(19) United States
(12) Patent Application Publication
(10) Pub. No.: US 2007/0232133 A1
(43) Pub. Date: Oct. 4, 2007

(54) Electronic device and signal connector thereof

(75) Inventor: Chih-Yung Chiu, Taipei Hsien (TW)

Correspondence Address: FROMMER LAWRENCE & HAUG, 745 FIFTH AVENUE- 10TH FL., NEW YORK, NY, 10151, US

(73) Assignee: AOPEN INC.

(21) Appl. No.: 11/633,387

(22) Filed: Dec. 4, 2006

(30) Foreign Application Priority Data
Apr. 3, 2006 (TW) 095205578

(51) Int. Cl. H01R 13/73

(52) U.S. Cl. 439/551

(57) ABSTRACT

An electronic device includes a housing, a circuit board, a conductive wire, and a signal connector. The housing includes a faceplate formed with a non-circular through-hole. The circuit board is mounted in the housing. The conductive wire is connected electrically to the circuit board. The signal connector includes a fixing portion extending through the through-hole, a connecting body connected to the fixing portion and accessible externally of the housing, a threaded connecting portion extending from the fixing portion opposite to the connecting body, and a limit component mounted on the threaded connecting portion and abutting against an inner plate surface of the faceplate. The threaded connecting portion is connected electrically to the conductive wire. The connecting body has a shoulder portion connected to the fixing portion and abutting against an outer plate surface of the faceplate, and a connecting portion extending from the shoulder portion opposite to the fixing portion.

### CROSS-REFERENCE TO RELATED APPLICATION

This application claims priority of Taiwanese application no. 095205578, filed on Apr. 3, 2006.

### BACKGROUND OF THE INVENTION

1. Field of the Invention

The invention relates to a signal connector of an electronic device, more particularly to a signal connector of an electronic device that can be positioned stably.

2. Description of the Related Art

As shown in FIG. 1, a conventional wireless network card 1 includes a circuit board 11 connected electrically to a computer motherboard, and a mounting frame 12 mounted on a rear side of the circuit board 11 for fixing on a computer housing. Connector sockets 111, 112, 113, 114 for mating with different signal transmission plugs are mounted on the circuit board 11 and extend through the mounting frame 12. Due to the presence of the connector sockets 111,112, 113, 114, the area of the circuit board 11 must be sufficiently large in design, thereby increasing occupied space inside a computer.

As shown in FIGS. 2 and 3, a conventional signal connector 2 of an electronic device usually extends through a circular through hole 201 in a faceplate 20. The signal connector 2 includes a main body 21, two washers 22 and a nut 23. The main body 21 has a base portion 211 connected electrically to a conductive wire 24, and a threaded connecting portion 212 extending from the base portion 211 in a direction opposite to the conductive wire 24. During assembly, one of the washers 22 is first sleeved on the threaded connecting portion 212 of the main body 21 and, after extending the threaded connecting portion 212 through the circular through hole 201 from an inner plate surface 202 of the faceplate 20, the other washer 22 is sleeved on and the nut 23 is threaded on the threaded connecting portion 212 that is exposed from an outer plate surface 203 of the faceplate 20 to complete assembly. The threaded connecting portion 212 exposed from the outer plate surface 203 of the faceplate 20 is for threaded connection with a signal transmission plug.

However, since the nut 23 is exposed from the outer plate surface 203 of the faceplate 20, the nut 23 is loosened easily due to frequent contact. Upon separation of the nut 23 from the threaded connecting portion 212, the main body 21 of the signal connector 2 will fall inside the electronic device such that the user must take apart the electronic device in order to mount the signal connector 2 once more on the faceplate 20. The procedure as such is both troublesome and inconvenient.

### SUMMARY OF THE INVENTION

Therefore, the main object of the present invention is to provide an electronic device that has a signal connector capable of being positioned stably and adapted for transmission of different signals.

Another object of the present invention is to provide a signal connector that can be positioned stably and that is adapted for transmission of different signals.

Accordingly, an electronic device of this invention comprises a housing, a circuit board, a conductive wire, and a signal connector.

The housing includes a faceplate formed with a non-circular through-hole. The circuit board is mounted in the housing. The conductive wire is connected electrically to the circuit board. The signal connector includes a fixing portion extending through the non-circular through-hole, a connecting body connected to the fixing portion and accessible externally of the housing, a threaded connecting portion extending from the fixing portion in a direction opposite to the connecting body, and a limit component mounted threadedly on the threaded connecting portion and abutting against an inner plate surface of the faceplate. The threaded connecting portion is connected electrically to one end of the conductive wire. The connecting body has a shoulder portion connected to the fixing portion and abutting against an outer plate surface of the faceplate that is opposite to the inner plate surface, and a connecting portion extending from the shoulder portion in a direction opposite to the fixing portion.

Preferably, the electronic device further comprises a first adapter that includes a first coupling portion for coupling with the connecting portion of the signal connector, and a second coupling portion disposed on one end opposite to the first coupling portion and adapted for connecting electrically with a cable plug for cable television.

Preferably, the electronic device further comprises a second adapter that includes a third coupling portion for coupling with the connecting portion of the signal connector, and a fourth coupling portion disposed on one end opposite to the third coupling portion and adapted for connecting electrically with a cable plug for wireless digital television.

Preferably, the non-circular through-hole has an inner hole-defining wall formed with a flat side. The threaded connecting portion is connected to the shoulder portion of the connecting body. The fixing portion is formed on an outer surface of the threaded connecting portion, and is formed as a flat face to abut against the flat side of the non-circular through-hole.

Preferably, the signal connector further includes a washer disposed between the limit component and the inner plate surface of the face plate. The washer includes a ring body abutting against the limit component, and a plurality of claws that are spaced apart from each other, that extend outwardly from an outer periphery of the ring body, and that extend inclinedly toward the faceplate to abut against the inner plate surface of the faceplate.

Preferably, the circuit board has a contact seat made of metal and mounted on a surface thereof, and the conductive wire has a contact member for connecting electrically with the contact seat.

In the electronic device of this invention, since the threaded connecting portion of the signal connector extends through the non-circular through-hole in the faceplate, since flat faces of the fixing portion of the signal connector and the non-circular through-hole abut against each other, and due to the presence of the washer and the limit component, the signal connector can be positioned stably on the faceplate of the housing. Moreover, because the first and second adapters can be coupled to the signal connector, flexibility in use is enhanced.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional wireless network card;

FIG. 2 is a side view showing a signal connector of a conventional electronic device;

FIG. 3 is an exploded side view of the signal connector of the conventional electronic device;

FIG. 4 is a top view of the preferred embodiment of an electronic device according to the present invention;

FIG. 5 is a side view of the preferred embodiment;

FIG. 6 is an exploded side view of the preferred embodiment;

FIG. 7 is a perspective view illustrating assembly of a signal connector of the preferred embodiment to a faceplate;

FIG. 8 is a schematic sectional view of the preferred embodiment taken along line 8-8 in FIG. 5;

FIG. 9 is a schematic view illustrating the preferred embodiment and a first adapter; and

FIG. 10 is a schematic view illustrating the preferred embodiment and a second adapter.

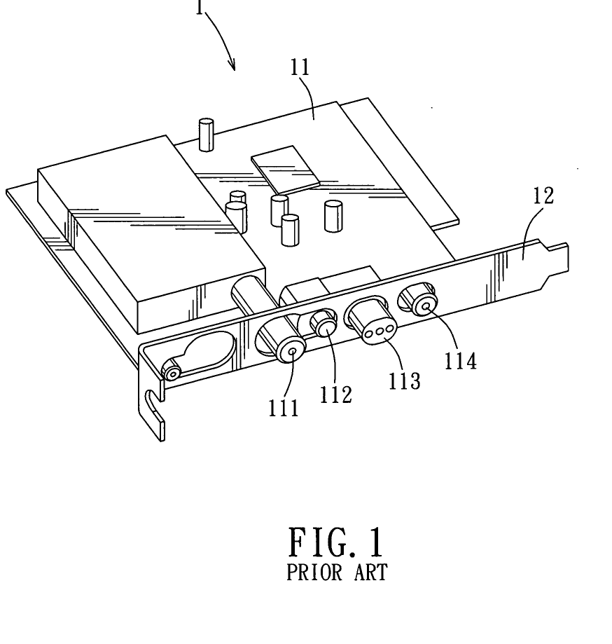

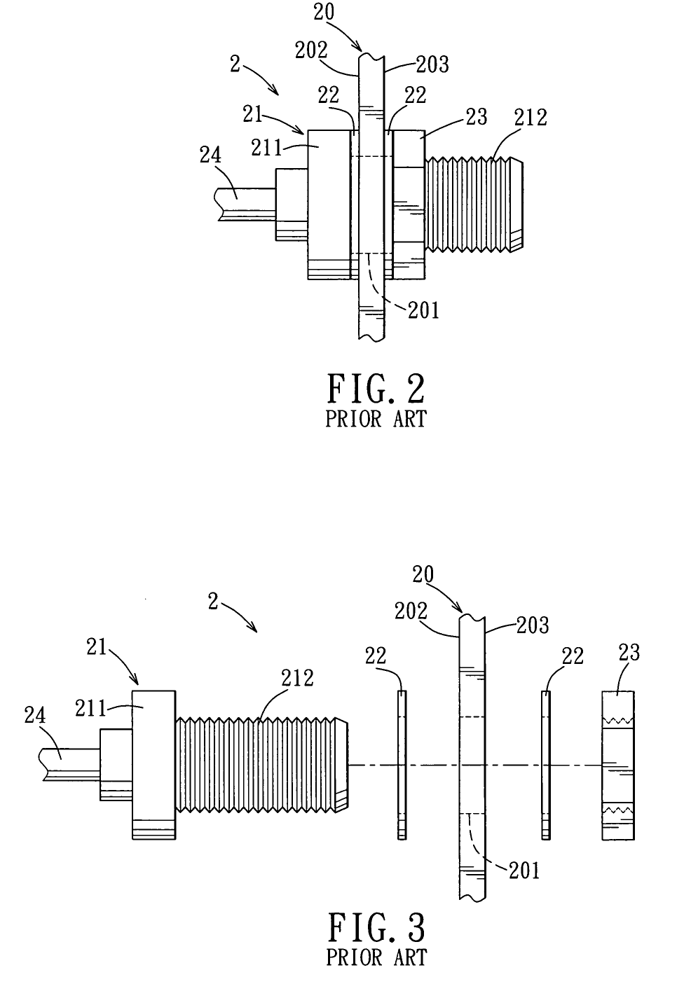

### DETAILED DESCRIPTION OF THE PREFERRED EMBODIMENT

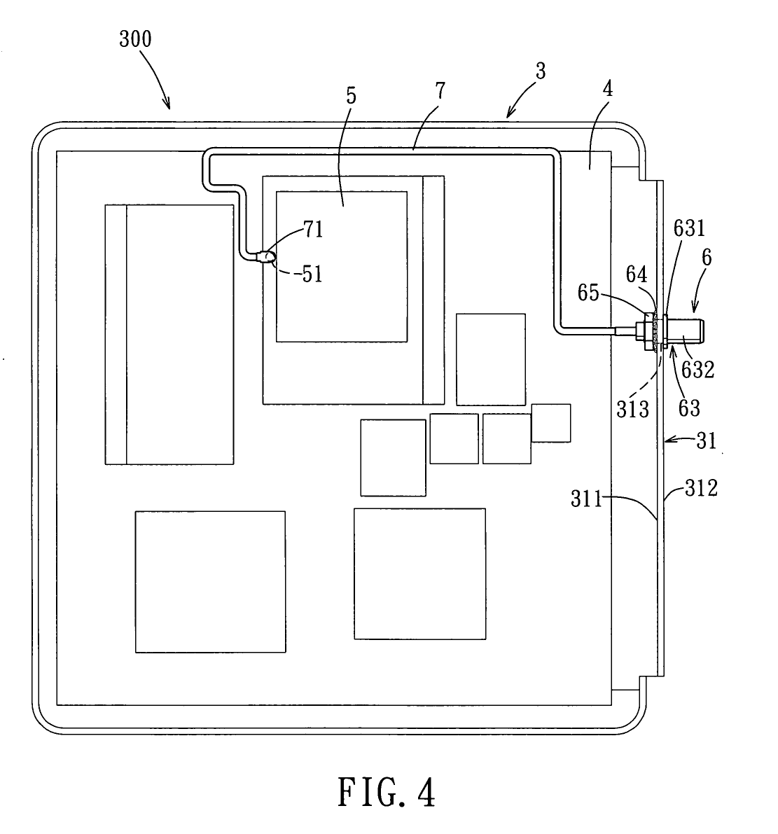

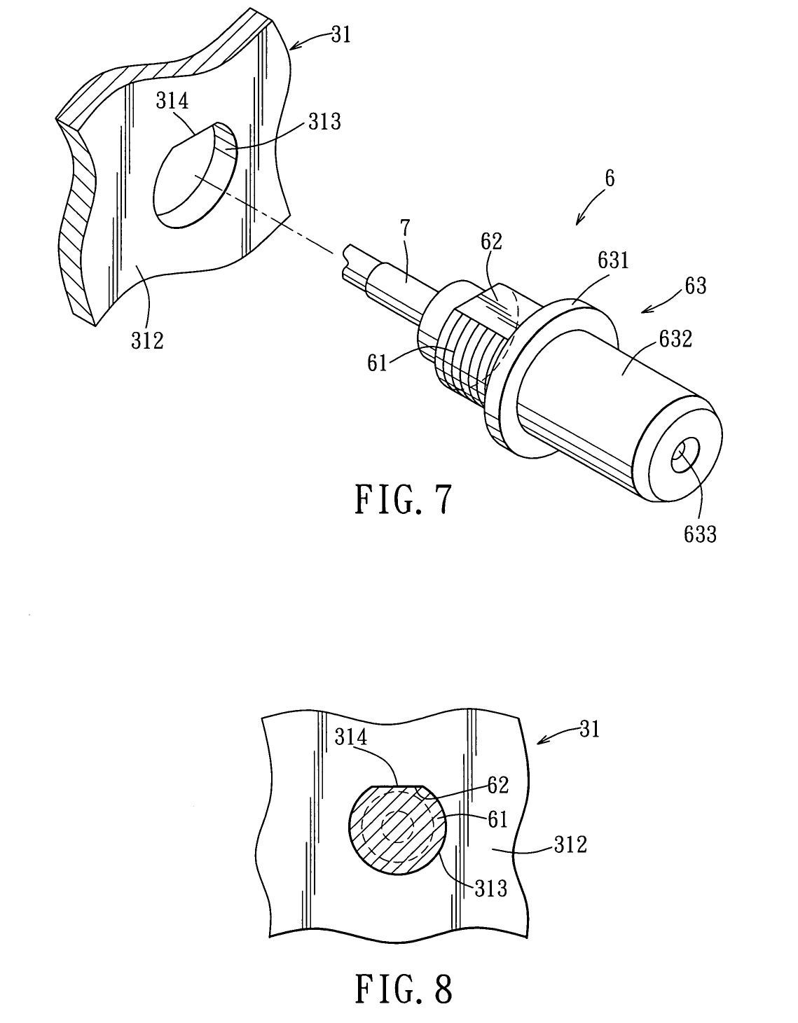

As shown in FIGS. 4, 5, 7 and 8, the preferred embodiment of an electronic device 300 according to the present invention is shown to be embodied in a computer that comprises a housing 3, a motherboard 4 mounted in the housing 3, a circuit board 5 mounted on and connected electrically to the motherboard 4, a signal connector 6 mounted on the housing 3, and a conductive wire 7 connected electrically between the circuit board 5 and the signal connector 6.

The housing 3 includes a faceplate 31 disposed at a rear side. The faceplate 31 has an inner plate surface 311, an outer plate surface 312 opposite to the inner plate surface 311, and a non-circular through-hole 313 that extends through the inner and outer plate surfaces 311, 312. The non-circular through-hole 313 has an inner hole-defining wall formed with a flat side 314 proximate to a top end thereof. The circuit board 5 is mounted on the motherboard 4 and is spaced apart from the inner plate surface 311 of the faceplate 31 by a distance. The circuit board 5 has a contact seat 51 made of metal and mounted on a surface thereof.

The signal connector 6 includes a threaded connecting portion 61 corresponding in position to the non-circular through-hole 313, a fixing portion 62 disposed on the threaded connecting portion 61, a connecting body 63 disposed at a rear side of the threaded connecting portion 61, a washer 64 made of metal and sleeved on the threaded connecting portion 61, and a limit component 65 capable of threaded engagement with the threaded connecting portion 61. The fixing portion 62 is formed on an outer surface of the threaded connecting portion 61 proximate to a top end thereof, and is formed as a flat face corresponding in position to the flat side 314 of the non-circular through-hole 313. The connecting body 63 has a shoulder portion 631 having an outer diameter larger than that of the threaded connecting portion 61 and connected to the threaded connecting portion 61, and a connecting portion 632 extending from one end of the shoulder portion 631 in a direction opposite to the threaded connecting portion 61 and having an outer diameter smaller than that of the shoulder portion 631. The outer surface of the connecting portion 632 is a smooth metal surface. The connecting portion 632 has an insert slot 633 formed in a center thereof. The washer 64 includes a ring body 641. Rearwardly inclining claws 642 are arranged spacedly on an outer surface of the ring body 641. The limit component 65 is a nut. The conductive wire 7 has one end connected electrically to the threaded connecting portion 61 of the signal connector 6, and the other end provided with a contact member 71 made of metal for coupling with the contact seat 51 of the circuit board 5.

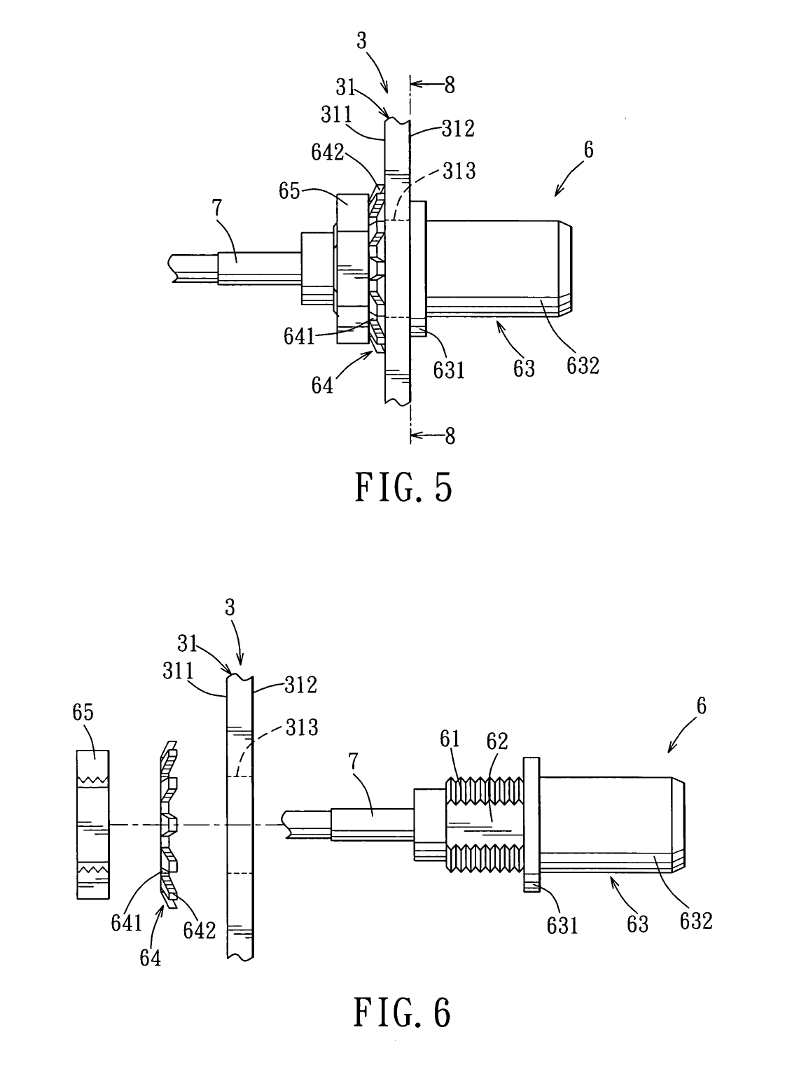

As shown in FIGS. 5, 6, 7 and 8, to assemble the signal connector 6 on the faceplate 31 of the housing 3, the conductive wire 7 connected to the threaded connecting portion 61 is first extended through the non-circular through-hole 313 from the outer plate surface 312 of the faceplate 31 toward the inner plate surface 311. After registering the position of the fixing portion 62 on the threaded connecting portion 61 with the position of the flat side 314 of the non-circular through-hole 313, the threaded connecting portion 61 is extended through the non-circular through-hole 313. At this time, because the fixing portion 62 abuts against the flat side 314, the threaded connecting portion 61 is unable to rotate relative to the non-circular through-hole 313. Since the outer diameter of the shoulder portion 631 of the connecting body 63 is larger than the inner diameter of the non-circular through-hole 313, after the threaded connecting portion 61 has moved inwardly of the non-circular through-hole 313 by a distance, the shoulder portion 631 will abut against the outer plate surface 312 of the faceplate 31 such that the connecting body 63 is unable to move further and is accessible externally of the housing 3.

Then, after the washer 64 is sleeved on the threaded connecting portion 61 that projects from the inner plate surface 311 of the faceplate 31, the limit component 65 is mounted threadedly on the threaded connecting portion 61. The limit component 65 presses against the ring body 641 of the washer 64 such that the claws 642 of the washer 64 abut against the inner plate surface 311 of the faceplate 31. By means of friction effect between the claws 642 and the inner plate surface 311 of the faceplate 31, the signal connector 6 can be fixed firmly and stably to the faceplate 31.

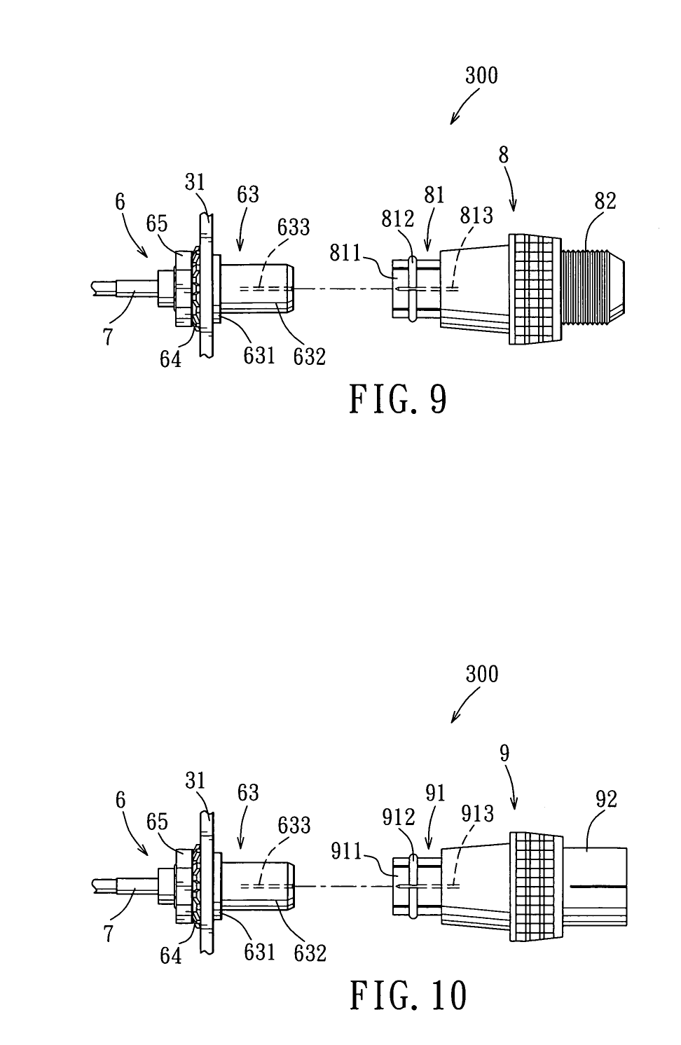

As shown in FIGS. 9 and 10, the electronic device 300 further comprises a first adapter 8 for coupling with the signal connector 6, and a second adapter 9 for coupling with the signal connector 6. The first adapter 8 includes a first coupling portion 81 for coupling with the connecting portion 632 of the signal connector 6, and a second coupling portion 82 disposed on one end opposite to the first coupling portion 81 and having an external screw thread on an outer surface thereof. The second coupling portion 82 is for connecting threadedly with a cable plug (not shown) for cable television so as to receive signals from a cable television cable (not shown). The second adapter 9 includes a third coupling portion 91 for coupling with the connecting portion 632 of the signal connector 6, and a fourth coupling portion 92 that is disposed on one end opposite to the third coupling portion 91 and that has a smooth outer surface. The fourth coupling portion 92 is for coupling with a cable plug (not shown) for wireless digital television so as to receive signals from a wireless digital television cable (not shown) Through the provision of the first and second adapters 8, 9, a user is able to select different manners of signal reception according to need, thereby enhancing flexibility in use.

Moreover, the first and third coupling portions 81, 91 have the same structure. In particular, each has a metal sleeve 811, 911 sleeved on the outer surface of the connecting portion 632 of the signal connector 6 and formed with a plurality of slits, a fastening ring 812, 912 sleeved fixedly on the surface of the metal sleeve 811, 911, and a conductive terminal 813, 913 mounted therein for insertion into the insert slot 633 of the connecting portion 632. Since the outer surface of the connecting portion 632 of the signal connector 6 is a smooth surface, the first and third adapters 8, 9 can be coupled to the signal connector 6 through direct sleeve engagement between the respective first or third coupling portion 81, 91 and the connecting portion 632 without the need for using a rotary coupling scheme. As a result, loosening of the signal connector 6 due to rotation can be avoided.

In sum, in the electronic device 300 of this embodiment, since the threaded connecting portion 61 of the signal connector 6 extends through the non-circular through-hole 313 in the face plate 31, since the fixing portion 62 of the signal connector 6 and the flat side 314 of the non-circular through-hole 313 abut against each other, and due to the presence of the washer 64 and the limit component 65, the signal connector 6 can be positioned stably on the faceplate 31 of the housing 3. Moreover, because the first and second adapters 8, 9 can be coupled to the signal connector 6, flexibility in use is enhanced, and there is no need to mount a plurality of connector sockets directly on the circuit board 5 so as to reduce design dimensions. The objects of this invention are thus achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electronic device comprising:
a housing including a faceplate formed with a non-circular through-hole;
a circuit board mounted in said housing;
a conductive wire connected electrically to said circuit board; and
a signal connector including
a fixing portion extending through said non-circular through-hole,
a connecting body connected to said fixing portion and accessible externally of said housing,
a threaded connecting portion extending from said fixing portion in a direction opposite to said connecting body, and
a limit component mounted threadedly on said threaded connecting portion and abutting against an inner plate surface of said faceplate,
said threaded connecting portion being connected electrically to one end of said conductive wire,
said connecting body having a shoulder portion connected to said fixing portion and abutting against an outer plate surface of said faceplate that is opposite to said inner plate surface, and a connecting portion extending from said shoulder portion in a direction opposite to said fixing portion.

2. The electronic device as claimed in claim 1, further comprising a first adapter that includes a first coupling portion for coupling with said connecting portion of said signal connector, and a second coupling portion disposed on one end opposite to said first coupling portion and adapted for connecting electrically with a cable plug for cable television.

3. The electronic device as claimed in claim 1, further comprising a second adapter that includes a third coupling portion for coupling with said connecting portion of said signal connector, and a fourth coupling portion disposed on one end opposite to said third coupling portion and adapted for connecting electrically with a cable plug for wireless digital television.

4. The electronic device as claimed in claim 1, wherein said non-circular through-hole has an inner hole-defining wall formed with a flat side, said threaded connecting portion being connected to said shoulder portion of said connecting body, said fixing portion being formed on an outer surface of said threaded connecting portion and being formed as a flat face to abut against said flat side of said non-circular through-hole.

5. The electronic device as claimed in claim 1, wherein said signal connector further includes a washer disposed between said limit component and said inner plate surface of said faceplate, said washer including a ring body abutting against said limit component, and a plurality of claws that are spaced apart angularly on said ring body and that abut against said inner plate surface of said faceplate.

6. The electronic device as claimed in claim 1, wherein said circuit board has a contact seat made of metal and mounted on a surface thereof, and said conductive wire has a contact member for connecting electrically with said contact seat.

7. A signal connector adapted for mounting on a housing, the housing including a faceplate formed with a non-circular through-hole, said signal connector comprising:
a connecting body having a shoulder portion for abutting against an outer plate surface of the faceplate, and a connecting portion extending from said shoulder portion in a direction opposite to the faceplate;
a fixing portion to be extended through the non-circular through-hole and connected to said shoulder portion;
a threaded connecting portion connected to said fixing portion and disposed on one end opposite to said connecting body; and
a limit component mounted threadedly on said threaded connecting portion for abutting against an inner plate surface of the faceplate that is opposite to the outer plate surface.

8. The signal connector as claimed in claim 7, wherein the non-circular through-hole has an inner hole-defining wall formed with a flat side, said threaded connecting portion being connected to said shoulder portion of said connecting body, said fixing portion being formed on an outer surface of said threaded connecting portion and being formed as a flat face to abut against the flat side of the non-circular through-hole.

9. The signal connector as claimed in claim 7, further comprising a washer to be disposed between said limit component and the inner plate surface of the faceplate, said washer including a ring body abutting against said limit component, and a plurality of claws that are spaced apart from each other, that extend outwardly from an outer periphery of said ring body, and that extend inclinedly toward the faceplate for abutting against the inner plate surface of the faceplate.
